(19) United States
(12) Patent Application Publication
(10) Pub. No.: US 2026/0299312 A1
(43) Pub. Date: Oct. 1, 2026

(54) COLLIMATOR BLOCK, COLLIMATION ASSEMBLY, AND LASER

(71) Applicants: WuHan Raycus Fiber Laser Technologies Co., Ltd, Wuhan, Hubei (CN); Optics Valley Laboratory, Wuhan, Hubei (CN)

(72) Inventors: Ziliang HAO, Wuhan, Hubei (CN); Wenjuan WANG, Wuhan, Hubei (CN); Huixuan HU, Wuhan, Hubei (CN); Sheng HE, Wuhan, Hubei (CN); Dapeng YAN, Wuhan, Hubei (CN)

(73) Assignees: WuHan Raycus Fiber Laser Technologies Co., Ltd, Wuhan, Hubei (CN); Optics Valley Laboratory, Wuhan, Hubei (CN)

(21) Appl. No.: 18/993,012

(22) PCT Filed: Nov. 1, 2023
(86) PCT No.: PCT/CN2023/129026

§ 371 Date: Jan. 10, 2025

(30) Foreign Application Priority Data
Apr. 26, 2023 (CN) 202310462932.7

(51) Int. Cl. G02B 27/30

(52) U.S. Cl. CPC G02B 27/30

(57) ABSTRACT

This application discloses a collimator block, a collimation assembly, and a laser. A first mounting member is provided with a through-hole mounting via. The mounting via includes a first via segment and a second via segment. The first via segment is used to mount a collimation lens. The second via segment is used to mount an optical fiber. A coefficient of thermal expansion of the second mounting member is less than a coefficient of thermal expansion of the first mounting member.

### TECHNICAL FIELD

The present application relates to the field of laser technology, and in particular to a collimator block, a collimation assembly, and a laser.

### BACKGROUND

In the existing technology, the laser light generated by a laser is generally first shaped; then, the beam of light is focused on a collimation lens of a collimation assembly through spatial beam combining, polarization beam combining, wavelength combining, etc., and finally is focused on an end face of an end of an output fiber through the collimation lens and is emitted from another end of the output fiber.

Since the beam of light is not symmetrical in a fast axis direction and a slow axis direction of the collimation lens, a single spherical collimation lens is insufficient to meet the requirement. Often, a set of beam expander lenses (a beam expander lens assembly) are necessary to achieve better beam focusing. As the power of the laser increases, a size of the beam expander lens assembly also needs to increase, which makes the beam expander lens susceptible to cracking.

### SUMMARY

Embodiments of the present disclosure provide a collimator block, a collimation assembly, and a laser, aiming to solve the problem that the beam expander lens of the collimation assembly is susceptible to cracking after the power of the laser is increased.

Some embodiments of the present disclosure provide a collimator block, including:
a first mounting member provided with a through-hole mounting via, wherein the mounting via comprises a first via segment and a second via segment that are sequentially connected in a length direction of the mounting via, the first via segment is used to mount a collimation lens, the second via segment is used to insert an input end of an optical fiber, so that the input end of the optical fiber is optically connected to an output end of the collimation lens; and
a second mounting member comprising a connection portion and a mounting portion, wherein the mounting portion is connected to a side of the connection portion away from the second via segment and close to the first via segment, the mounting portion is used to mount a beam expander lens assembly, so as to optically connect an output end of the beam expander lens assembly and an input end of the collimation lens. A coefficient of thermal expansion of the second mounting member is less than a coefficient of thermal expansion of the first mounting member.

In some embodiments, the collimator block further includes a heat dissipation channel, wherein at least part of the heat dissipation channel is located in the first mounting member, and at least another part of the heat dissipation channel is located in the second mounting member.

In some embodiments, a first guide groove is provided on a side surface of the first mounting member facing the connection portion, a second guide groove is provided on a side surface of the connection portion facing the first mounting member, and the first guide groove and the second guide groove enclose to form the heat dissipation channel.

In some embodiments, a first groove opening and a second groove opening are respectively formed on the side surface of the first mounting member at two ends of the first guide groove away from the first via segment and close to the second via segment. A third groove opening and a fourth groove opening are respectively formed on the side surface of the connection portion at two ends of the second guide groove away from the first via segment and close to the second via segment. The first groove opening and the third groove opening enclose to form an inlet of the heat dissipation channel, and the second groove opening and the fourth groove opening enclose form an outlet of the heat dissipation channel.

In some embodiments, the heat dissipation channel includes a plurality of sub-channels connected in sequence, the plurality of sub-channels are arranged in parallel, and each sub-channel extends along the length direction of the mounting via.

In some embodiments, the first mounting member is made of metal, the second mounting member is made of ceramic, and a surface of the first mounting member facing the connection portion and a surface of the connection portion facing the first mounting member are connected through welding.

In some embodiments, the second mounting member is made of diamond, silicon nitride, silicon nitride, or silicon boride.

In some embodiments, the coefficient of thermal expansion of the second mounting member is less than or equal to 8.

In some embodiments, the mounting portion has a mounting surface on a side of the connection portion facing the first mounting member, the mounting surface is provided with a mounting groove for mounting the beam expander lens assembly, and a glue overflow groove is provided on an edge of a bottom surface of the mounting groove.

In some embodiments, the beam expander lens comprises a convex lens and a concave lens.

The convex lens is located between the concave lens and the collimation lens, and the concave lens, the convex lens, and the collimation lens are optically connected in sequence; or the concave lens is located between the convex lens and the collimation lens, and the convex lens, the concave lens, and the collimation lens are optically connected in sequence.

Some embodiments of the present disclosure further provide a collimation assembly, including: a collimator block, a beam expander lens assembly, a collimation lens, and an optical fiber.

The collimator block includes a first mounting member and a second mounting member. The first mounting member is provided with a through-hole mounting via, wherein the mounting via comprises a first via segment and a second via segment that are sequentially connected in a length direction of the mounting via, the first via segment is used to mount the collimation lens, the second via segment is used to insert an input end of the optical fiber, so that the input end of the optical fiber is optically connected to an output end of the collimation lens. The second mounting member comprises a connection portion and a mounting portion, the mounting portion is connected to a side of the connection portion away from the second via segment and close to the first via segment, the mounting portion is used to mount the beam expander lens assembly, so as to optically connect an output end of the beam expander lens assembly and an input end of the collimation lens. A coefficient of thermal expansion of the second mounting member is less than a coefficient of thermal expansion of the first mounting member.

The beam expander lens assembly is mounted on the mounting portion of the second mounting member of the collimator block.

The collimation lens is mounted in the first via segment of the collimator block, and the input end of the collimation lens is optically connected to the output end of the beam expander lens assembly.

The input end of the optical fiber is inserted into the second via segment of the collimator block, so that the input end of the optical fiber is optically connected with the output end of the collimation lens.

In some embodiments, the collimator block further includes a heat dissipation channel, wherein at least part of the heat dissipation channel is located in the first mounting member, and at least another part of the heat dissipation channel is located in the second mounting member.

In some embodiments, a first guide groove is provided on a side surface of the first mounting member facing the connection portion, a second guide groove is provided on a side surface of the connection portion facing the first mounting member, and the first guide groove and the second guide groove enclose to form the heat dissipation channel.

In some embodiments, a first groove opening and a second groove opening are respectively formed on the side surface of the first mounting member at two ends of the first guide groove away from the first via segment and close to the second via segment. A third groove opening and a fourth groove opening are respectively formed on the side surface of the connection portion at two ends of the second guide groove away from the first via segment and close to the second via segment. The first groove opening and the third groove opening enclose to form an inlet of the heat dissipation channel, and the second groove opening and the fourth groove opening enclose form an outlet of the heat dissipation channel.

In some embodiments, the heat dissipation channel includes a plurality of sub-channels connected in sequence, the plurality of sub-channels are arranged in parallel, and each sub-channel extends along the length direction of the mounting via.

In some embodiments, the first mounting member is made of metal, the second mounting member is made of ceramic, and a surface of the first mounting member facing the connection portion and a surface of the connection portion facing the first mounting member are connected through welding.

In some embodiments, the second mounting member is made of diamond, silicon nitride, silicon nitride, or silicon boride.

In some embodiments, the coefficient of thermal expansion of the second mounting member is less than or equal to 8.

In some embodiments, the mounting portion has a mounting surface on a side of the connection portion facing the first mounting member, the mounting surface is provided with a mounting groove for mounting the beam expander lens assembly, and a glue overflow groove is provided on an edge of a bottom surface of the mounting groove.

Some embodiments of the present disclosure further provide a laser, including:
a laser light source; and
the collimation assembly as described above, wherein an input end of the beam expander lens assembly of the collimation assembly is optically connected to an output end of the laser light source.

### BENEFICIAL EFFECTS

In the collimator block provided by some embodiments of the present disclosure, the first mounting member is used to mount the collimation lens and the input end of the optical fiber, the second mounting member is used to mount the beam expander lens assembly, and the first mounting member is connected with the second mounting member, wherein the coefficient of thermal expansion of the second mounting member is smaller than the coefficient of thermal expansion of the first mounting member. Therefore, an expansion size of the heated collimator block will be reduced, which reduces the stress on the beam expander lenses mounted on the second mounting member, thereby further reducing a risk of cracking of the beam expander lens assembly to a certain extent.

### BRIEF DESCRIPTION OF THE DRAWINGS

In order to more clearly illustrate the technical solutions in the embodiments of the present disclosure, the drawings needed to be used in the description of the embodiments will be briefly introduced below. Apparently, the drawings in the following description are only some embodiments of the present disclosure. For those skilled in the art, other drawings can also be obtained based on these drawings without exerting creative efforts.

FIG. 1 is a schematic structural diagram of a collimation assembly according to some embodiments of the present disclosure.

FIG. 2 is a perspective view of the collimation assembly in FIG. 1.

FIG. 3 is an exploded structural diagram of the collimation assembly in FIG. 2.

FIG. 4 is a cross-sectional view of a first mounting member along an axial direction of a mounting via according to some embodiments of the present disclosure.

FIG. 5 is a schematic structural diagram of a second mounting member according to some embodiments of the present disclosure.

### DESCRIPTION OF REFERENCE SIGNS

collimation assembly 100; collimator block 110; first mounting member 111; mounting via 1111; first via segment 1112; second via segment 1113; accommodation groove 1114; first guide groove 1115; first groove opening 1116; second groove opening 1117; second mounting member 112; connection portion 1121; mounting portion 1122; mounting surface 1123; mounting groove 1124; notch 1125; bottom surface 1126; identification line 1127; glue overflow groove 1128; second guide groove 1129; third groove opening 1130; fourth groove opening 1131; heat dissipation channel 1100; inlet 1101; outlet 1102; sub-channel 1103; optical fiber 113; collimation lens 114; beam expander lens assembly 115; convex lens 1151; concave lens 1152; fixing member 116; and end cap 117.

### EMBODIMENTS OF THE DISCLOSURE

The technical solutions in the embodiments of the present disclosure will be clearly and completely described below with reference to the accompanying drawings in the embodiments of the present application. Obviously, the described embodiments are only some of the embodiments of the present application, rather than all of the embodiments. Based on the embodiments in the present disclosure, all other embodiments obtained by those skilled in the art without making creative efforts fall within the scope of protection of the present disclosure. In addition, it should be understood that the specific embodiments described here are only used to illustrate and explain the present disclosure, and are not used to limit the application. In the present disclosure, unless otherwise specified, the directional words used such as “upper” and “lower” usually refer to the upper and lower position of a device in actual use or working state, specifically the direction of the drawing in the drawings, while “inside” and “outside” is relative to the outline of the device.

Embodiments of the present disclosure provide a collimator block, a collimation assembly, and a laser. Each is explained in detail below.

First, some embodiments of the present application provide a collimator block.

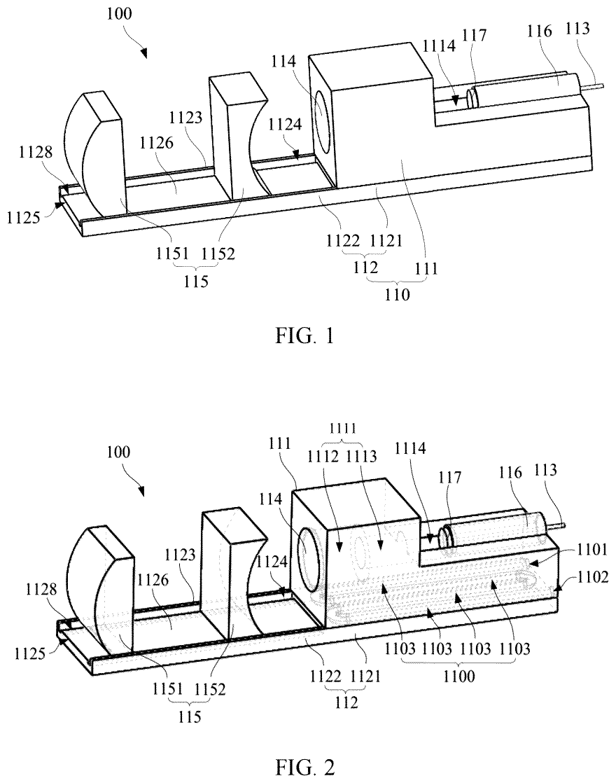

FIG. 1 is a schematic structural diagram of a collimation assembly according to some embodiments of the present disclosure. As shown in FIG. 1, a collimation assembly 100 includes a collimator block 110, an optical fiber 113, and a collimation lens 114. The collimation assembly 100 is a part of a laser (not shown in the figure). An input end of the optical fiber 113 is mounted on the collimator block 110, and the collimation lens 114 is mounted on the collimator block 110. An input end of the collimation lens 114 of the collimating assembly 100 is configured to be optically connected with an output end of a laser light source of the laser, so that laser light generated by the laser light source enters the optical fiber 113 from the output end of the optical fiber 113 after being collimated by the collimation lens 114 and is outputted from an output end of optical fiber 113.

The laser is a semiconductor laser. The laser light source of the semiconductor laser includes multiple laser chips. After the laser light generated by the multiple laser chips are shaped by an optical component, the multiple beams of laser light are combined through spatial beam combining, polarization beam combining, wavelength combining, etc. The combined beam is focused onto an end face of the input end of the optical fiber 113 through the collimation lens 114, and is emitted from an end face of the output end of the optical fiber 113, thereby achieving high-power and high-brightness output of the semiconductor laser. Of course, the laser may be other types of lasers, which are not limited here.

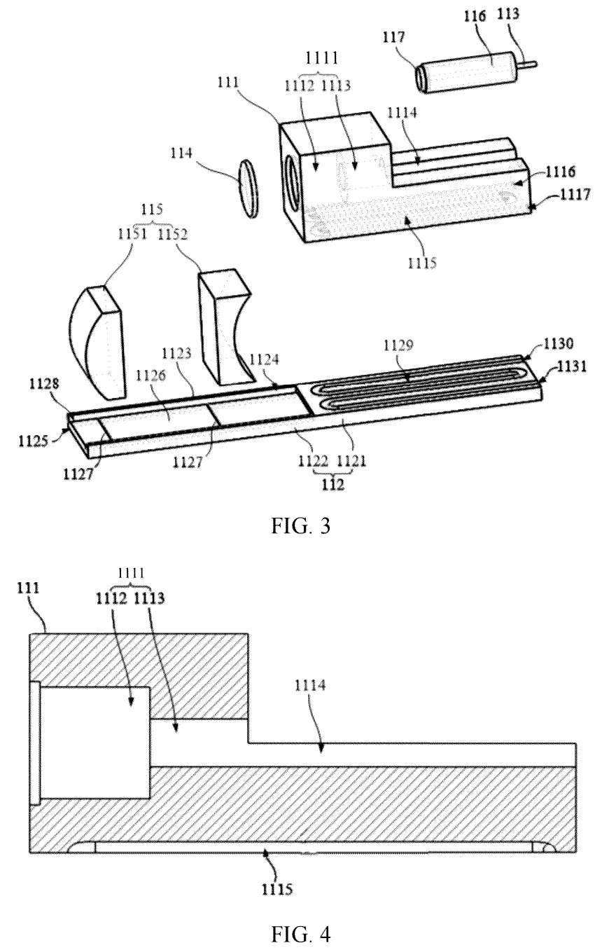

Since the beam is not symmetrical in a fast axis direction and a slow axis direction of the collimation lens 114, the collimation lens 114 alone cannot meet beam quality requirements. Therefore, as shown in FIGS. 1 to 3, a beam expander lens assembly 115 may be mounted on the collimator block 110, and an output end of the beam expander lens assembly 115 is optically connected to the input end of the collimator lens 114. The laser output from the laser light source first enters the beam expander lens assembly 115 from an input end of the beam expander lens assembly 115, and is emitted from the output end of the beam expander lens assembly 115, then is collimated by the collimation lens 114, and then enters the optical fiber 113 from the input end of the optical fiber 113 and is emitted from the end face of the output end of the optical fiber 113.

Specifically, the beam expander lens assembly 115 includes a convex lens 1151 and a concave lens 1152. The convex lens 1151 may be located between the concave lens 1152 and the collimation lens 114. The concave lens 1152, the convex lens 1151, and the collimation lens 114 are optically connected in sequence. An input end of the concave lens 1152 is the input end of the beam expander lens assembly 115, and an output end of the convex lens 1151 is the output end of the beam expander lens assembly 115. Alternatively, the concave lens 1152 may be located between the convex lens 1151 and the collimation lens 114. The convex lens 1151, the concave lens 1152, and the collimation lens 114 are optically connected in sequence. An input end of the convex lens 1151 is the input end of the beam expander lens assembly 115, and an output end of the concave lens 1152 is the output end of the beam expander lens assembly 115.

As the power of the laser increases, the components of the beam expander lens assembly 115 are often susceptible to cracking during an operation of the laser, thereby affecting the working stability of the laser. The inventor has found through research that as the laser power increases, a size of the beam expander lens assembly 115 and a size of the collimation lens 114 also increase. In some collimation assemblies 100, the convex lens 1151 and the concave lens 1152 of the beam expander lens assembly 115 may have their size increased from 6 mm*6 mm to 8 mm*10 mm, resulting in serious mismatch between the size of the beam expander lens assembly 115 and a coefficient of thermal expansion (CTE) of the collimator block 110. When the size of the beam expander lens assembly 115 increases, a stress generated by thermal expansion of the collimator block 110 is too large, causing the beam expander lens assembly 115 to crack. Moreover, after the power of the laser is increased, the temperature of the beam expander lens assembly 115 continues to increase, which will further accelerate cracking of the beam expander lens assembly 115.

In order to avoid the problem that the beam expander lens assembly 115 of the collimation assembly 100 is susceptible to cracking after the power of the laser is increased, some embodiments of the present disclosure provide a collimator block 110. As shown in FIGS. 1 to 3, the collimator block 110 includes a first mounting member 111 and a second mounting member 112. The first mounting member 111 is used to mount the collimation lens 114 and the input end of the optical fiber 113. The input end of the optical fiber 113 is located on an optical path of the output end of the collimation lens 114. The input end of the optical fiber 113 is optically connected to the output end of the collimation lens 114.

As shown in FIGS. 2 to 4, the first mounting member 111 is provided with a through-hole mounting via 1111. The mounting via 1111 includes a first via segment 1112 and a second via segment 1113 that are sequentially connected in a length direction of the mounting via 1111. The first via segment 1112 is used to mount the collimation lens 114, and the second via segment 1113 is used to insert the input end of the optical fiber 113, so that the input end of the optical fiber 113 is optically connected to the output end of the collimation lens 114. Thus, by mounting the collimation lens 114 in the first via segment 1112 of the mounting via 1111 and inserting the input end of the optical fiber 113 into the second via segment 1113 of the mounting via 1111, the collimation lens 114 and the optical fiber 113 may be mounted in the first mounting member 111, and the input end of the optical fiber 113 is optically connected to the output end of the collimation lens 114, making the mounting more convenient.

In some embodiments, as shown in FIGS. 1 to 3, the collimation assembly 100 includes a fixing member 116, which is sleeved on an outer peripheral surface of the input end of the optical fiber 113, so that the input end of the optical fiber 113 is connected to the fixing member 116. By inserting the fixing member 116 into the second via segment 1113 of the mounting via 1111, the input end of the optical fiber 113 may be inserted into the second via segment 1113, which improves mounting accuracy and mounting stability of the fiber 113 in the first mounting member 111. In addition, the collimation assembly 100 further includes an end cap 117 to be fused to the end face of the input end of the optical fiber 113. The end cap 117 can help reduce power density of the end face of the input end of the optical fiber 113, thereby improving reliability of the optical fiber 113.

In some embodiments, as shown in FIGS. 1 to 4, the first mounting member 111 is further provided with an accommodation groove 1114, which extends along the length direction of the mounting via 1111 and is connected with an end of the mounting via 1111 away from the first via segment 1112 and close to the second via segment 1113. When the input end of the optical fiber 113 is inserted into the second via segment 1113 of the mounting via 1111, a portion of the optical fiber 113 close to the output end of the optical fiber 113 will be accommodated in the accommodating groove 1114, so that the accommodation groove 1114 can somewhat serve as a protecting and limiting structure for the portion of the optical fiber 113 close to the output end of the optical fiber 113.

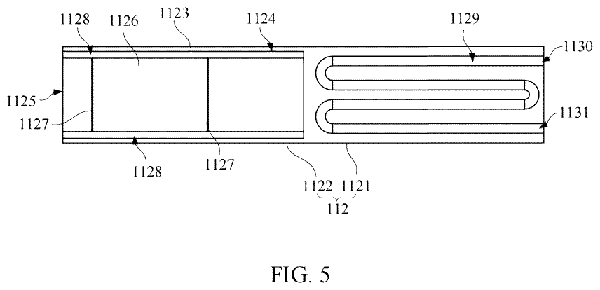

Continuing to refer to FIGS. 1-3 and 5, the second mounting member 112 is used to mount the beam expander lens assembly 115, and the output end of the beam expander lens assembly 115 is optically connected to the input end of the collimation lens 114. The second mounting member 112 includes a connection portion 1121 and a mounting portion 1122. The connection portion 1121 is connected to the first mounting member 111, and the mounting portion 1122 is connected to a side of a connection portion 1121 away from the second via segment 1113 and close to the first via segment 1112. The mounting portion 1122 is used to mount the beam expander lens assembly 115, so that the output end of the beam expander lens assembly 115 and the input end of the collimation lens 114 are optically connected. When the input end of the beam expander lens assembly 115 is optically connected to the output end of the laser light source of the laser, the laser light output from the output end of the laser light source passes through the beam expander lens assembly 115 and the collimation lens 114 in sequence, and then enters the optical fiber 113 from the input end of the optical fiber 113 and is emitted from the output end of the optical fiber 113, improving the quality of the beam of light.

In some embodiments, a coefficient of thermal expansion (CTE) of the second mounting member 112 is less than a coefficient of thermal expansion of the first mounting member 111. In some embodiments of the present disclosure, the first mounting member 111 of the collimator block 110 is used to mount the collimation lens 114 and the input end of the optical fiber 113, the second mounting member 112 of the collimator block 110 is used to mount the beam expander lens assembly 115, and the first mounting member 111 is connected with the second mounting member 112, wherein the coefficient of thermal expansion of the second mounting member 112 is smaller than the coefficient of thermal expansion of the first mounting member 111. Therefore, an expansion size of the collimator block 110 when heated will be reduced, which reduces the stress, generated by the thermal expansion of the second mounting member 11, on the beam expander lens assembly 115 mounted on the second mounting member 112, thereby further reducing a risk of cracking of the beam expander lens assembly 115 to a certain extent.

The coefficient of thermal expansion of the second mounting member 112 may be made less than or equal to 8 to further reduce the expansion size of the collimator block 110 after being heated, thereby further reducing the risk of cracking of the beam expander lens assembly 115. The coefficient of thermal expansion of the second mounting member 112 may be 1, 3, 4, 5, etc., which may be determined based on the coefficient of thermal expansion of the beam expander lens assembly 115 and a material of the second mounting member 112.

In some embodiments, the second mounting member 112 is made of ceramic. Therefore, the coefficient of thermal expansion of the second mounting member 112 is closer to the coefficient of thermal expansion of the beam expander lens assembly 115, which can minimize the stress on the beam expander lens assembly 115 generated by the thermal expansion of the second mounting member 112 and better prevent the beam expander lens assembly 115 from cracking. In addition, the second mounting member 112 will have a better thermal conductivity effect to dissipate heat from the beam expander lens assembly 115, thereby avoiding excessive stress on the beam expander lens assembly 115 due to excessive temperature, since the excessive stress generated by the excessive temperature may cause the beam expander lens assembly 115 to crack. Specific materials of the second mounting member 112 include diamond, silicon nitride, silicon nitride, silicon boride, and other ceramic materials with low coefficient of thermal expansion and high thermal conductivity efficiency.

In some embodiments, as shown in FIGS. 1-3 and 5, the mounting portion 1122 of the second mounting member 112 has a mounting surface 1123 on a side of the connection portion 1121 facing the first mounting member 111. The mounting surface 1123 is used for mounting the beam expander lens assembly 115. Specifically, the beam expander lens assembly 115 is mounted on the mounting surface 1123 along an extending direction of the mounting via 1111 of the first mounting member 111. One or more glue overflow grooves 1128 are provided on the mounting surface 1123.

It can be understood that the beam expander lens assembly 115 is generally adhered to the mounting surface 1123 of the mounting portion 1122 through glue. When an installer presses the beam expander lens assembly 115, the glue located between the beam expander lens assembly 115 and the mounting surface 1123 (without any glue overflow groove) will be squeezed and spread along a side surface of the beam expander lens assembly 115 (for example, the glue spreads to mirror surfaces of the concave lens 1152 or the convex lens 1151), thereby affecting optical performance of the beam expander lens assembly 115. At the same time, the glue spreading to the side surface of the beam expander lens assembly 115 will further increase the stress caused by the thermal expansion of the beam expander lens assembly 115.

In some embodiments of the present disclosure, the glue overflow groove 1128 is provided on the mounting surface 1123 of the mounting portion 1122 for mounting the beam expander lens assembly 115. When the installer presses the beam expander lens assembly 115, the glue between the beam expander lens assembly 115 and the mounting surface 1123 will flow into the glue overflow groove 1128, and thus will not accumulate or spread onto the side surface of the beam expander lens assembly 115, which avoids the glue from affecting the optical performance of the beam expander lens assembly 115, and reduces the stress generated by the thermal expansion of the lens assembly 115, thereby further reducing the risk of cracking of the beam expander lens assembly 115.

The mounting surface 1123 of the mounting portion 1122 has a mounting groove 1124 for mounting the beam expander lens assembly 115. By mounting the beam expander lens assembly 115 in the mounting groove 1124, the beam expander lens assembly 115 may be accurately positioned to ensure that the beam expander lens assembly 115 is located on the optical path of the output end of the collimation lens 114. The glue overflow groove 1128 is provided on an edge of a bottom surface 1126 of the mounting groove 1124.

Specifically, the mounting groove 1124 extends along the extending direction of the mounting via 1111. The mounting groove 1124 is formed with a notch 1125 on an edge of the mounting surface 1123 away from the first mounting member 111. The convex lens 1151 and the concave lens 1152 of the beam expander lens assembly 115 are mounted on the bottom surface 1126 of the mounting groove 1124 in the extending direction of the mounting via 1111. The glue overflow grooves 1128 are respectively provided on two sides of the bottom surface 1126 of the mounting groove 1124. The glue overflow grooves 1128 extend along the extending direction of the mounting via 1111.

In some embodiments, the mounting surface 1123 of the mounting portion 1122 of the second mounting member 112 is provided with an identification line 1127, which is used to identify a mounting position of the beam expander lens assembly 115 to achieve rapid and accurate mounting of the beam expander lens assembly 115. Specifically, the mounting surface 1123 of the mounting portion 1122 of the second mounting member 112 is provided with two identification lines 1127. The two identification lines 1127 are sequentially distributed along the extending direction of the mounting via 1111. One of the identification lines 1127 is used to position the convex lens 1151 of the beam expander lens assembly 115, and the other identification line 1127 is used to position the concave lens 1152 of the beam expander lens assembly 115.

The mounting surface 1123 of the mounting portion 1122 of the second mounting member 112 is provided with a strip groove to form the identification line 1127. When the mounting surface 1123 of the mounting portion 1122 of the second mounting member 112 has the mounting groove 1124, the identification line 1127 is located on the bottom surface 1126 of the mounting groove 1124.

In some embodiments, the second mounting member 112 is arranged in a plate shape. The first mounting member 111 is connected to a plate surface of the second mounting member 112. A portion of the second mounting component 112 corresponding to the first mounting member 111 is the connection portion 1121. A portion of the second mounting member 112 located on a side of the connection portion 1121 away from the second via segment 1113 and close to the first via segment 1112 is the mounting portion 1122. The mounting surface 1123 is located on a plate surface of the second mounting member 112. A thickness of the second mounting member 112 may be 1 to 2 mm.

In some embodiments, as shown in FIG. 2, the collimator block 110 further includes a heat dissipation channel 1100, and at least part of the heat dissipation channel 1100 is located in the second mounting member 112. Therefore, cooling medium may be circulated in the heat dissipation channel 1100 to quickly dissipate heat of the second mounting member 112 to reduce the temperatures of the beam expander lens assembly 115, the glue, and the second mounting member 112, thereby reducing the expansion sizes of the beam expander lens assembly 115 and the second mounting member 112 after thermal expansion, and further reducing the risk of cracking of the beam expander lens assembly 115. Besides, an aging speed of the glue on the second mounting member 112 may also be reduced.

In addition, at least part of the heat dissipation channel 1100 is located in the first mounting member 111. As a result, the cooling medium may be circulated in the heat dissipation channel 1100 to quickly dissipate heat from the first mounting member 111, reduce the temperature of the input end of the optical fiber 113 and the collimation lens 114, and prevent the input end of the optical fiber 113 and the collimation lens 114 from being damaged by their excessive temperatures.

It should be noted that the cooling medium of the heat dissipation channel 1100 may be water, refrigerant, or other fluids that can take away the first mounting member 111 and/or the mounting member, which is not limited here.

In some embodiments, as shown in FIGS. 2 to 5, the connection portion 1121 of the second mounting member 112 and the first mounting member 111 may enclose to form a heat dissipation channel 1100, so that the cooling medium may circulate in the heat dissipation channel 1100 to dissipate the heat in the first mounting member 111 and in the second mounting member. Of course, the heat dissipation channel 1100 may include a first heat dissipation section and a second heat dissipation section that are connected in sequence. The first heat dissipation section is located in the first mounting member 111 and the second heat dissipation section is located in the connection portion 1121 of the second mounting member 112.

A first guide groove 1115 is provided on a side surface of the first mounting member 111 facing the connection portion 1121, and a second guide groove 1129 is provided on a side surface of the connection portion 1121 of the second mounting member 112 facing the first mounting member 111. The first guide groove 1115 and the second guide groove 1129 enclose to form the heat dissipation channel 1100.

Therefore, the side surface of the first guide groove 1115 is machined to form the first guide groove 1115, the side surface of the connection portion 1121 of the second mounting member 112 is machined to form the second mounting groove 1124, and the side surface of the first mounting member 111 facing the connection portion 1121 is connected to the side surface of the connection portion 1121 of the second mounting member 112 facing the first mounting member 111. Thus, the heat dissipation channel 1100 is formed between the first mounting member 111 and the second mounting member 112, which makes the processing of the collimator block 110 more convenient.

Continuing to refer to FIGS. 2 to 5, a first groove opening 1116 and a second groove opening 1117 are respectively formed on the side surface of the first mounting member 111 at two ends of the first guide groove 1115 away from the first via segment 1112 and close to the second via segment 1113. A third groove opening 1130 and a fourth groove opening 1131 are respectively formed on the side surface of the connection portion 1121 at two ends of the second guide groove 1129 away from the first via segment 1112 and close to the second via segment 1113. The first groove opening 1116 and the third groove opening 1130 enclose to form an inlet 1101 of the heat dissipation channel 1100, and the second groove opening 1117 and the fourth groove opening 1131 enclose form an outlet 1102 of the heat dissipation channel 1100. In this way, the inlet 1101 of the heat dissipation channel 1100 may be connected to an outlet 1102 of a cooling medium circulation pump, and the inlet 1101 of the heat dissipation channel 1100 may be connected to an inlet 1101 of the cooling medium circulation pump, so as to realize cooling medium circulation flow in the heat dissipation channel 1100.

In some embodiments, as shown in FIG. 2, the heat dissipation channel 1100 includes a plurality of sub-channels 1103 that are connected in sequence. The plurality of sub-channels 1103 are arranged in parallel, and each sub-channel 1103 extends along the length direction of the mounting via 1111. Therefore, a length of the heat dissipation channel 1100 in the collimator block 110 may be increased to further improve a cooling effect of the cooling medium in the heat dissipation channel(s) 1100 in the first mounting member 111 and in the second mounting member 112 of the collimator block 110.

Each sub-channel 1103 of the heat dissipation channel 1100 may be entirely located between the first mounting member 111 and the mounting portion 1122 of the second mounting member 112. Alternatively, a part of the sub-channels 1103 of the heat dissipation channel 1100 may be located inside the first mounting member, and the other part of the sub-channels 1103 may be located inside the second mounting member 112.

In addition, an extending direction of the plurality of sub-channels 1103 of the heat dissipation channel 1100 may be at an angle with the length direction of the mounting via 1111, which may be determined according to the structures of the first mounting member 111 and the second mounting member 112 of the collimator block 110.

In some embodiments, the first mounting member 111 is made of metal. As a result, a structural strength of the first mounting member 111 may be improved. Moreover, the first mounting member 111 may quickly dissipate heat from the collimation lens 114 and the input end of the optical fiber 113.

In some embodiments, a surface of the first mounting member 111 facing the connection portion 1121 and a surface of the connection portion 1121 facing the first mounting member 111 are connected through welding to improve the connection stability of the first mounting member 111 and the second mounting member 112. Moreover, when the heat dissipation channel 1100 is formed between the first mounting member 111 and the connection portion 1121 of the second mounting member 112, by welding the surface of the first mounting member 111 facing the connection portion 1121 and the surface of the connection portion 1121 facing the first mounting member 111, the sealing performance therebetween may be improved, which prevents the cooling medium in the heat dissipation channel 1100 from leaking out between the first mounting member 111 and the connection portion 1121.

The surface of the first mounting member 111 facing the connection portion 1121 and the surface of the connection portion 1121 facing the first mounting member 111 may be welded together by eutectic welding, soldering, or other methods, which are not limited here.

The embodiments of the present disclosure further provide a collimation assembly. The collimation assembly includes a collimator block. The specific structure of the collimator block may refer to the above-mentioned embodiments. Since the collimation assembly and the laser may adopt all the technical solutions of the above-mentioned embodiments, therefore they have at least all the beneficial effects brought by the technical solutions of the above embodiments, which will not be repeated herein.

The collimation assembly 100 includes a collimator block 110, an optical fiber 113, a collimation lens 114, and a beam expander lens assembly 115. The collimator block 110 is the collimator block 110 in any of the above embodiments. The beam expander lens assembly 115 is mounted on the mounting portion 1122 of the second mounting member 112 of the collimator block 110. The collimation lens 114 is mounted in the first via segment 1112 of the collimator block 110, and the output end of the beam expander lens assembly 115 is optically connected to the input end of the collimation lens 114. The input end of the optical fiber 113 is inserted into the second via segment 1113 of the collimator block 110, so that the input end of the optical fiber 113 is optically connected with the output end of the collimation lens 114.

The embodiments of the present disclosure further provide a laser. The laser includes a collimation assembly. The specific structure of the collimation assembly may refer to the above-mentioned embodiments. Since this laser may adopt all the technical solutions of the above-mentioned embodiments, therefore it has at least all the beneficial effects brought by the technical solutions of the above embodiments, which will not be repeated herein.

The laser includes a laser light source and a collimation assembly 100. The collimation assembly 100 is the above-mentioned collimation assembly 100. The beam expander lens assembly 115 of the collimation assembly 100 is optically connected to the output end of the laser light source.

In the above embodiments, each embodiment has its own emphasis in the description. For parts that are not described in detail in a certain embodiment, please refer to the relevant descriptions of other embodiments.

The above has introduced in detail a collimator block, a collimation assembly, and a laser provided by some embodiments of the present disclosure. Specific examples are used in the present disclosure to illustrate the principles and implementation methods of the present disclosure. The description of the above embodiments is only to help understand the methods and core ideas of the present disclosure. At the same time, for those skilled in the art, there may be changes in the specific implementation and application scope based on the ideas of the present disclosure. In summary, the content of the description should not be construed as a limitation on the present disclosure.

1. A collimator block, comprising:
a first mounting member provided with a through-hole mounting via, wherein the mounting via comprises a first via segment and a second via segment that are sequentially connected in a length direction of the mounting via, the first via segment is used to mount a collimation lens, the second via segment is used to insert an input end of an optical fiber, so that the input end of the optical fiber is optically connected to an output end of the collimation lens; and
a second mounting member comprising a connection portion and a mounting portion, wherein the mounting portion is connected to a side of the connection portion away from the second via segment and close to the first via segment, the mounting portion is used to mount a beam expander lens assembly, so as to optically connect an output end of the beam expander lens assembly and an input end of the collimation lens,
wherein a coefficient of thermal expansion of the second mounting member is less than a coefficient of thermal expansion of the first mounting member.

2. The collimator block of claim 1, further comprising a heat dissipation channel, wherein at least part of the heat dissipation channel is located in the first mounting member, and at least another part of the heat dissipation channel is located in the second mounting member.

3. The collimator block of claim 2, wherein a first guide groove is provided on a side surface of the first mounting member facing the connection portion, a second guide groove is provided on a side surface of the connection portion facing the first mounting member, and the first guide groove and the second guide groove enclose to form the heat dissipation channel. (Currently Amended) The collimator block of claim 3, wherein a first groove opening and a second groove opening are respectively formed on the side surface of the first mounting member at two ends of the first guide groove away from the first via segment and close to the second via segment,
a third groove opening and a fourth groove opening are respectively formed on the side surface of the connection portion at two ends of the second guide groove away from the first via segment and close to the second via segment, and
the first groove opening and the third groove opening enclose to form an inlet of the heat dissipation channel, and the second groove opening and the fourth groove opening enclose form an outlet of the heat dissipation channel.

5. The collimator block of claim 3, wherein the heat dissipation channel comprises a plurality of sub-channels connected in sequence, the plurality of sub-channels are arranged in parallel, and each sub-channel extends along the length direction of the mounting via.

6. The collimator block of claim 1, wherein the first mounting member is made of metal, the second mounting member is made of ceramic, and a surface of the first mounting member facing the connection portion and a surface of the connection portion facing the first mounting member are connected through welding.

7. The collimator block of claim 6, wherein the second mounting member is made of diamond, or silicon boride.

8. The collimator block of claim 1, wherein the coefficient of thermal expansion of the second mounting member is less than or equal to 8.

9. The collimator block of claim 1, wherein the mounting portion has a mounting surface on a side of the connection portion facing the first mounting member, the mounting surface is provided with a mounting groove for mounting the beam expander lens assembly, and a glue overflow groove is provided on an edge of a bottom surface of the mounting groove.

10. The collimator block of claim 1, wherein the beam expander lens comprises a convex lens and a concave lens;
wherein the convex lens is located between the concave lens and the collimation lens, and the concave lens, the convex lens, and the collimation lens are optically connected in sequence, or
the concave lens is located between the convex lens and the collimation lens, and the convex lens, the concave lens, and the collimation lens are optically connected in sequence.

11. A collimation assembly, comprising a collimator block, a beam expander lens assembly, a collimation lens, and an optical fiber, wherein:
the collimator block comprises a first mounting member and a second mounting member,
wherein the first mounting member is provided with a through-hole mounting via, wherein the mounting via comprises a first via segment and a second via segment that are sequentially connected in a length direction of the mounting via, the first via segment is used to mount the collimation lens, the second via segment is used to insert an input end of the optical fiber, so that the input end of the optical fiber is optically connected to an output end of the collimation lens,
the second mounting member comprises a connection portion and a mounting portion, the mounting portion is connected to a side of the connection portion away from the second via segment and close to the first via segment, the mounting portion is used to mount the beam expander lens assembly, so as to optically connect an output end of the beam expander lens assembly and an input end of the collimation lens, and
a coefficient of thermal expansion of the second mounting member is less than a coefficient of thermal expansion of the first mounting member;
the beam expander lens assembly is mounted on the mounting portion of the second mounting member of the collimator block;
the collimation lens is mounted in the first via segment of the collimator block, and the input end of the collimation lens is optically connected to the output end of the beam expander lens assembly; and
the input end of the optical fiber is inserted into the second via segment of the collimator block, so that the input end of the optical fiber is optically connected with the output end of the collimation lens.

12. The collimation assembly of claim 11, wherein the collimator block further comprising a heat dissipation channel, at least part of the heat dissipation channel is located in the first mounting member, and at least another part of the heat dissipation channel is located in the second mounting member.

13. The collimation assembly of claim 12, wherein a first guide groove is provided on a side surface of the first mounting member facing the connection portion, a second guide groove is provided on a side surface of the connection portion facing the first mounting member, and the first guide groove and the second guide groove enclose to form the heat dissipation channel.

14. The collimation assembly of claim 13, wherein a first groove opening and a second groove opening are respectively formed on the side surface of the first mounting member at two ends of the first guide groove away from the first via segment and close to the second via segment,
a third groove opening and a fourth groove opening are respectively formed on the side surface of the connection portion at two ends of the second guide groove away from the first via segment and close to the second via segment, and
the first groove opening and the third groove opening enclose to form an inlet of the heat dissipation channel, and the second groove opening and the fourth groove opening enclose form an outlet of the heat dissipation channel.

15. The collimation assembly of claim 13, wherein the heat dissipation channel comprises a plurality of sub-channels connected in sequence, the plurality of sub-channels are arranged in parallel, and each sub-channel extends along the length direction of the mounting via.

16. The collimation assembly of claim 11, wherein the first mounting member is made of metal, the second mounting member is made of ceramic, and a surface of the first mounting member facing the connection portion and a surface of the connection portion facing the first mounting member are connected through welding.

17. The collimation assembly of claim 16, wherein the second mounting member is made of diamond, or silicon boride.

18. The collimation assembly of claim 11, wherein the coefficient of thermal expansion of the second mounting member is less than or equal to 8.

19. The collimation assembly of claim 11, wherein the mounting portion has a mounting surface on a side of the connection portion facing the first mounting member, the mounting surface is provided with a mounting groove for mounting the beam expander lens assembly, and a glue overflow groove is provided on an edge of a bottom surface of the mounting groove.

20. A laser, comprising:
a laser light source; and
a collimation assembly comprising: a collimator block, beam expander lens assembly, a collimation lens, and an optical fiber, wherein:
the collimator block comprises a first mounting member and a second mounting member,
wherein the first mounting member is provided with a through-hole mounting via, wherein the mounting via comprises a first via segment and a second via segment that are sequentially connected in a length direction of the mounting via, the first via segment is used to mount the collimation lens, the second via segment is used to insert an input end of the optical fiber, so that the input end of the optical fiber is optically connected to an output end of the collimation lens,
the second mounting member comprises a connection portion and a mounting portion, the mounting portion is connected to a side of the connection portion away from the second via segment and close to the first via segment, the mounting portion is used to mount the beam expander lens assembly, so as to optically connect an output end of the beam expander lens assembly and an input end of the collimation lens, and
a coefficient of thermal expansion of the second mounting member is less than a coefficient of thermal expansion of the first mounting member;
the beam expander lens assembly is mounted on the mounting portion of the second mounting member of the collimator block;
the collimation lens is mounted in the first via segment of the collimator block, and the input end of the collimation lens is optically connected to the output end of the beam expander lens assembly; and
the input end of the optical fiber is inserted into the second via segment of the collimator block, so that the input end of the optical fiber is optically connected with the output end of the collimation lens;
wherein an input end of the beam expander lens assembly of the collimation assembly is optically connected to an output end of the laser light source.
